(19) United States
(12) Patent Application Publication
(10) Pub. No.: US 2013/0168363 A1
(43) Pub. Date: Jul. 4, 2013

(54) WIRE ELECTRIC DISCHARGE MACHINE HAVING DIELECTRIC HEATING TUBE

(71) Applicant: FANUC CORPORATION, Yamanashi (JP)

(72) Inventor: Yasuo ARAKAWA, Minamitsuru-gun (JP)

(73) Assignee: FANUC CORPORATION, Yamanashi (JP)

(21) Appl. No.: 13/670,844

(22) Filed: Nov. 7, 2012

(30) Foreign Application Priority Data
Dec. 28, 2011 (JP) 2011-287822

(51) Int. Cl. B23H 1/04

(52) U.S. Cl. CPC B23H 1/04
USPC 219/69.15

(57) ABSTRACT

In the wire electric discharge machine, a heat resistant tube in which a wire electrode is inserted and a coil which is wound around the heat resistant tube and causes high frequency dielectric heating are arranged on a downstream side of a device which applies the tension to a wire electrode led from a wire bobbin but on the upstream side of an upper guide portion. Further, a turn density of the coil in a section (annealing section) of the heat resistant tube close to the inlet of the wire electrode is made lower than a coil turns density in a section (fusing and cutting section) close to an outlet of the wire electrode.

### BACKGROUND OF THE INVENTION

1. Field of the Invention

The present invention relates to a wire electric discharge machine having a dielectric heating tube.

2. Description of the Related Art

A wire cut electric discharge machine is automatically operated even at night to improve the operating rate. When a mold component is machined by a wire electric discharge machine, a plurality of penetration holes having desired shapes are machined in a target workpiece. Such penetration holes are machined by making machining start holes of about 2 to 10 mm in a target workpiece in advance, cutting into this machining start hole and cutting out the desired shape by wire electric discharge machining.

To automatically machine a target workpiece using a wire cut electric discharge machine, a wire is automatically inserted in one of a plurality of machining start holes made in advance in hole machining portions of this target workpiece and is relatively moved with respect to the target workpiece to perform machining. Further, when machining is finished, the wire is automatically cut, it is necessary to perform operations of moving the wire to a next machining start hole, and automatically inserting the wire again. A series of these operations are performed by a wire automatic connection device of the wire electric discharge machine.

Hence, a wire connection success rate of this wire automatic connection device significantly influences the operating rate. That is, when the connection success rate is low and connection is not successful, an unattended operation stops in the middle, the machine stops and, as a result, the operating rate decreases. By contrast with this, when the connection success rate is high, the operating rate increases.

Generally, a wire electrode has a wire diameter of about 0.1 to 0.3 mm and is wound around a bobbin having the diameter of about 100 mm in units of 5 to 10 kg, and is fed from the bobbin upon use and is used. The wire electrode which is wound around the bobbin for a long time has deteriorated straightness, and is in a bent state, that is, in a curved state upon feeding.

In this curled state, when the wire electrode is fed from an upper guide, the wire electrode does not travel straight to a lower guide, then travels toward a portion astray from a position of the lower guide due to a bend of the wire itself and therefore is not inserted in the lower guide. Hence, particularly when a target workpiece is thick and a distance between the upper guide and the lower guide is long, the wire electrode needs to have high straightness to make the wire fed from the upper guide reliably reach the lower guide.

Further, when a wire having poor straightness is directly used for machining, a target workpiece is subjected to electric discharge machining in a curled state, and therefore the curled shape is transferred to a machining surface of the target workpiece. When, for example, a wire is fed from above to below and the wire is curled from the right to the left, if a square hole is machined in this wire, a center portion on the left side of the machining surface swells and a center portion on the right side of the machining surface dents, and therefore machining precision becomes poor.

What is important in automation of a wire automatic connection function in a wire electric discharge machine is to continuously perform a series of unmanned operations of inserting a wire in a machining start hole, cutting the wire after machining is finished, moving the wire to a next machining start position and inserting the wire in this machining start hole.

This operation of cutting a wire includes a method of mechanically cutting a wire using, for example, a cutter, a method of fusing the wire by applying currents to upper and lower ends of the wire and heating the wire by Joule heat of the current flowing the wire as disclosed in Japanese Patent Application Laid-Open (JP-A) Nos. 58-132420 and 2006-7400 and a method of cutting a wire heated by a high frequency current by applying a high frequency current to a coil arranged around a wire from an outside as disclosed in JP-A No. 61-8225.

However, the wire cutting methods of the above known techniques have the following drawbacks, and therefore cannot increase the success rate of automatic connection.

First, the method of mechanically cutting a wire electrode 2 using, for example, a cutter has a drawback that, when the soft and yellow copper wire electrode 2 is cut by the cutter (not illustrated), this wire electrode 2 is crushed by this cutter as illustrated in FIG. 4, the cut portion changes to an oval shape, some portions have large diameters compared to the diameter of a true circle and the wire electrode 2 does not pass through a highly precise dice guide 30 of narrow clearance. Hence, a guide of wide clearance is used with a sacrifice of precision, and an openable guide is used out of necessity at a risk of breakdown of mechanical parts. Further, when the cutter wears away, the front end of a cut portion is not well cut, burrs are produced and the front end does not pass through the dice guide, and therefore it is necessary to make a frequent exchange and adjustment of an expensive cutter.

In case of wire fusing using Joule heat disclosed in JP-A Nos. 58-132420 and 2006-7400 mentioned above, as illustrated in FIG. 5, a structure is required which makes a high voltage electrode contact on one of the vicinities of the wire cut portion by means of a mechanical chuck structure and makes an earth side electrode contact on the other of the vicinities and applies a direct current. FIG. 6 illustrates that a hard wire that has no scratch owing to contact thermal cutting can be inserted smoothly in the highly precise dice guide 30.

However, when this electrode is contacted on a columnar wire surface, if a wire is strongly pinched to reliably apply a current, a pinching scratch is produced on a surface of soft and yellow copper and, similarly, there is a drawback that the wire does not pass through the highly precise dice guide 30 of narrow clearance. Further, when the wire is weakly pinched because of a concern of a pinching scratch, poor connection occurs and a burn is produced due to contact resistance between an electrode and a wire and a projection such as an electric discharge scratch is produced and, similarly, there is a drawback that the wire does not pass through the highly precise dice guide 30 of narrow clearance.

Particularly, a soft wire which is required upon taper grinding has a surface which is susceptible to scratches, has a flexible body, and, therefore, when the wire passes through the dice guide, the wire is bent due to a slight increase in passing resistance caused by this scratch, the wire cannot pass through the dice guide in the end and the connection performance decreases (see FIG. 7).

Next, features of the dielectric heating method using a high frequency current disclosed in JP-A No. 61-8225 (see FIG. 8) include heating and fusing a wire in a non-contact manner and causing less contact damages on the wire than the mechanical cutter and the contact current supply method (see FIG. 9). Further, in the case of such dielectric heating method, cooling air is not required and upper and lower electrodes are not required. However, a portion of this wire which needs to be fused is not annealed, and therefore it is not possible to improve straightness of the wire. Hence, as illustrated in FIG. 10, upon connection of wire in a start hole of a thick target workpiece, it is difficult to insert the wire in a lower guide due to a bend of the wire (see FIG. 10).

Further, when a wire having poor straightness is used directly for machining, a target workpiece is subjected to electric discharge machining by the wire in a curled state, and therefore the curled shape of the wire is transferred to a machining surface of the workpiece. When, for example, a wire is fed from above to below and the wire is curled from the right to the left, if a square hole is machined in this wire, there is a problem that a center portion on the left side of the machining surface swells and a center portion on the right side of the machining surface dents, and therefore machining precision becomes poor.

### SUMMARY OF THE INVENTION

It is therefore an object of the present invention to provide a wire electric discharge machine which heats a wire electrode by high frequency dielectric heating using a coil in a non-contact state and improves straightness of the wire upon connection and straightness of the wire during machining to improve a connection rate of wire automatic connection and improve shape precision during machining.

In order to achieve this purpose and improve the connection rate of the wire, a wire electric discharge machine is required which, when cutting the wire, can cut the wire without leaving contact damages on the wire and obtain a sharp front end and provide a wire having straightness in a range corresponding to the distance from a separate upper guide and lower guide. Further, this wire electric discharge machine needs to correct a bend of the wire during machining.

Hence, the present invention provides a wire electric discharge machine which improves straightness of a wire by applying a high frequency current to a coil and heating and annealing the wire by dielectric heat generated inside the wound coil, and fuses the wire by locally heating the wire. The high frequency current applied to the coil is supplied from an electric discharge power source of the wire electric discharge machine or a dedicated power source device, and the magnitude of the frequency can be easily set from the electric discharge controller of the wire electric discharge machine.

The wire electric discharge machine according to the present invention comprises a wire tension applying device which leads a wire electrode wound around a wire bobbin and applies a tension to the wire electrode, an upper guide portion which is provided on an upper portion of an electric discharge machining area, and a wire running route which goes through a lower guide portion provided in a lower portion of the electric discharge machining area. In this wire electric discharge machine, a dielectric heating tube, which is formed with a heat resistant tube in which the wire electrode is inserted and a coil which is wound around the heat resistant tube and causes high frequency dielectric heating, is arranged on a downstream side of the wire tension applying device but on the upstream side of the upper guide portion. And, a turns density of the coil in a first section of the heat resistant tube between an upper end portion on the wire electrode inlet side and an intermediate portion which is a predetermined distance away from a lower end portion on the wire electrode outlet side toward the upper end portion is made lower than a turns density of the coil in a second section of the heat resistant tube between the lower end portion and the intermediate point.

The present invention provides a device which heats a wire electrode by high frequency dielectric heating using a coil in a non-contact manner and improves straightness of the wire upon connection and improves straightness during machining to improve the connection rate of wire automatic connection and improve shape precision during machining.

### BRIEF DESCRIPTION OF THE DRAWINGS

The above and other objects and features of the present invention will be made obvious from the following description of an embodiment with reference to the accompanying drawings. Among these drawings:

FIG. 1 is a schematic diagram for describing a wire electric discharge machine according to the present invention;

FIG. 2 is a block diagram for describing a controller which controls the wire electric discharge machine in FIG. 1;

FIG. 3 is a view for explaining a dielectric heating method of a dielectric heating tube with a variable pitch coil adopted in the wire electric discharge machine according to the present invention;

FIG. 4 is a view for explaining that a wire abuts on a highly precise dice guide due to a burr produced upon mechanical cutting;

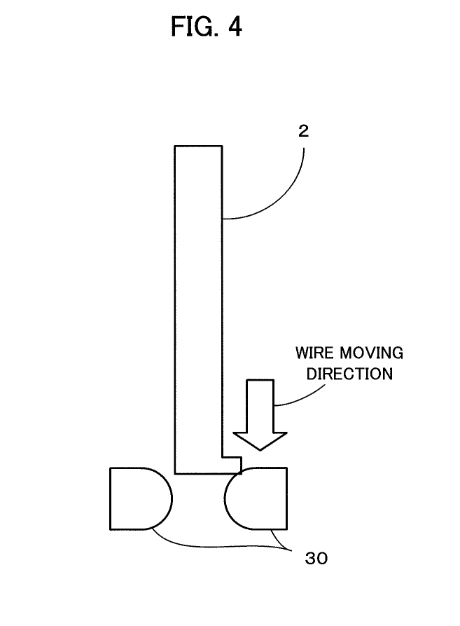

FIG. 5 is a view for explaining a direct current heating method of a conventional electrode pinching structure;

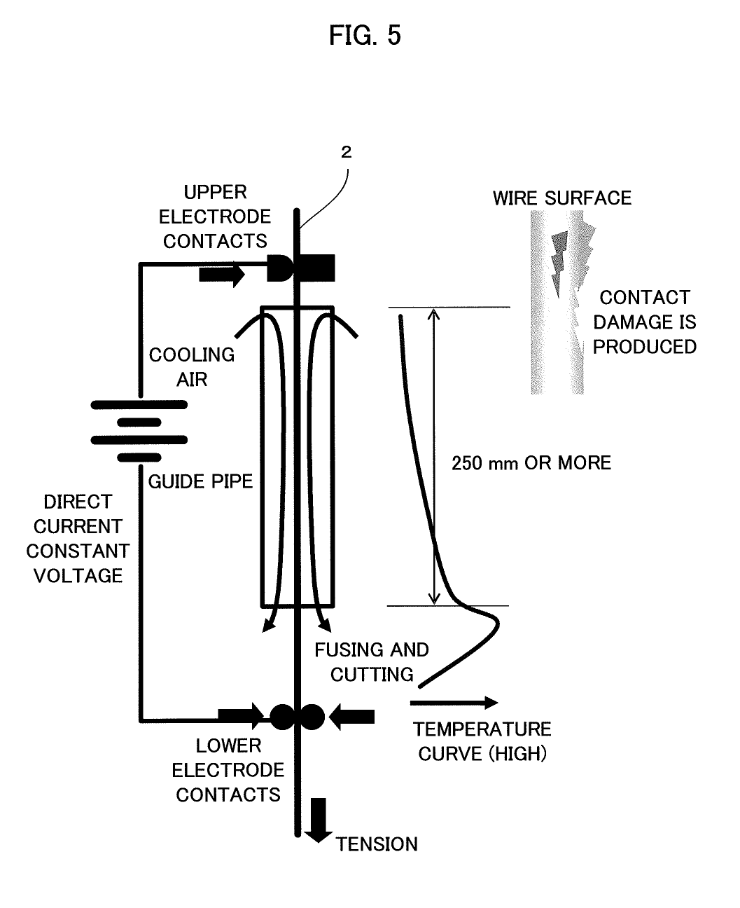

FIG. 6 is a view for explaining that a hard wire which is scratch-resistant upon contact cutting can be smoothly inserted in a highly precise dice guide;

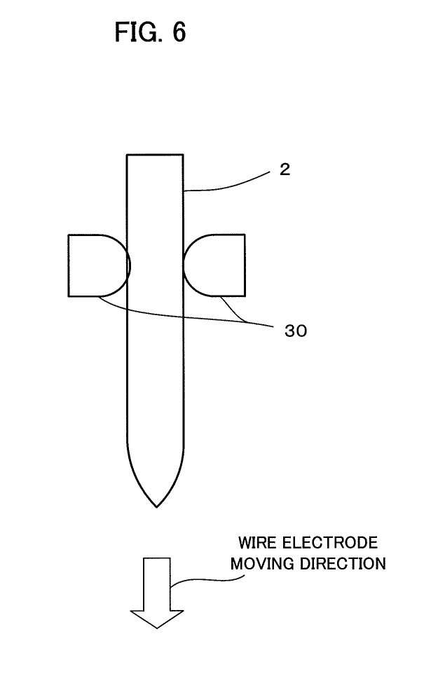

FIG. 7 is a view for explaining that a scratch is produced on a wire surface due to contact cutting and the wire abuts on the highly precise dice guide;

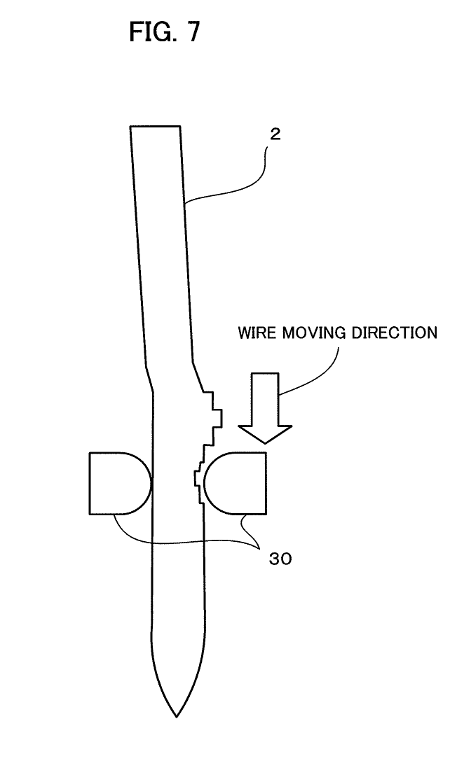

FIG. 8 is a view for explaining a dielectric heating method of a tube with a coil;

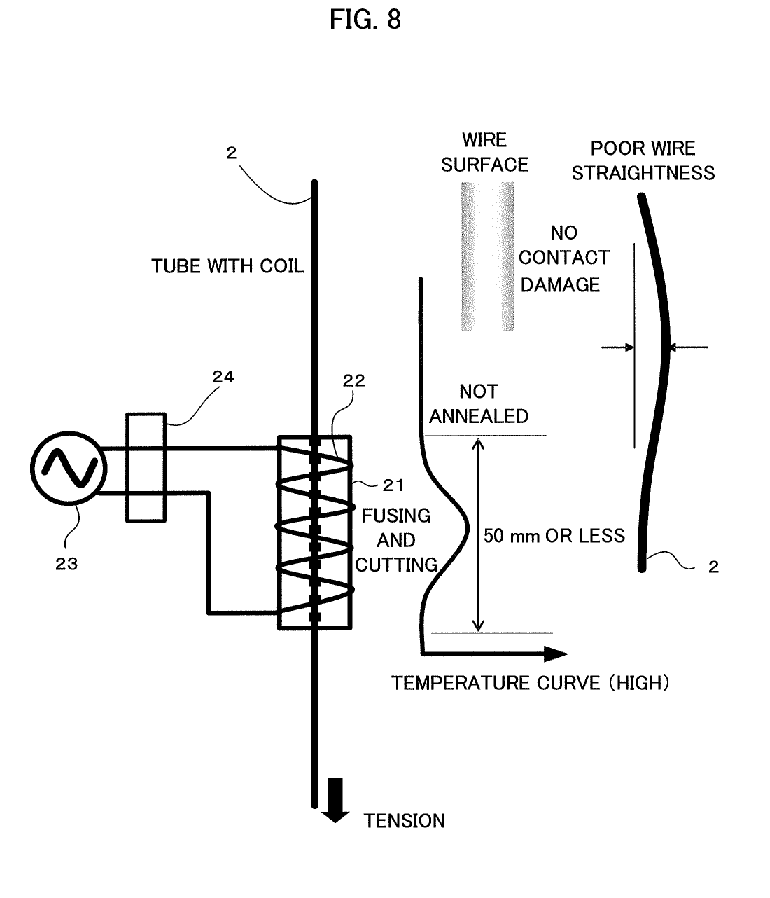

FIG. 9 is a view for explaining that a wire can be smoothly inserted in the highly precise dice guide according to the dielectric heating method using the tube with the coil; and

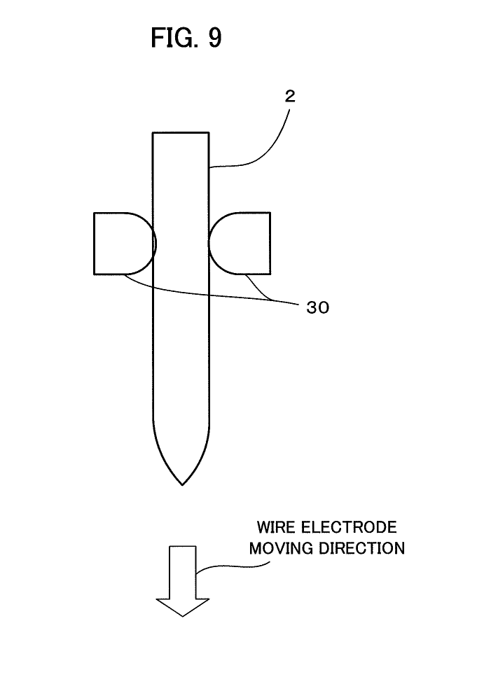

FIG. 10 is a view for explaining a difference in a connection rate due to a difference in straightness resulting from whether or not annealing is performed.

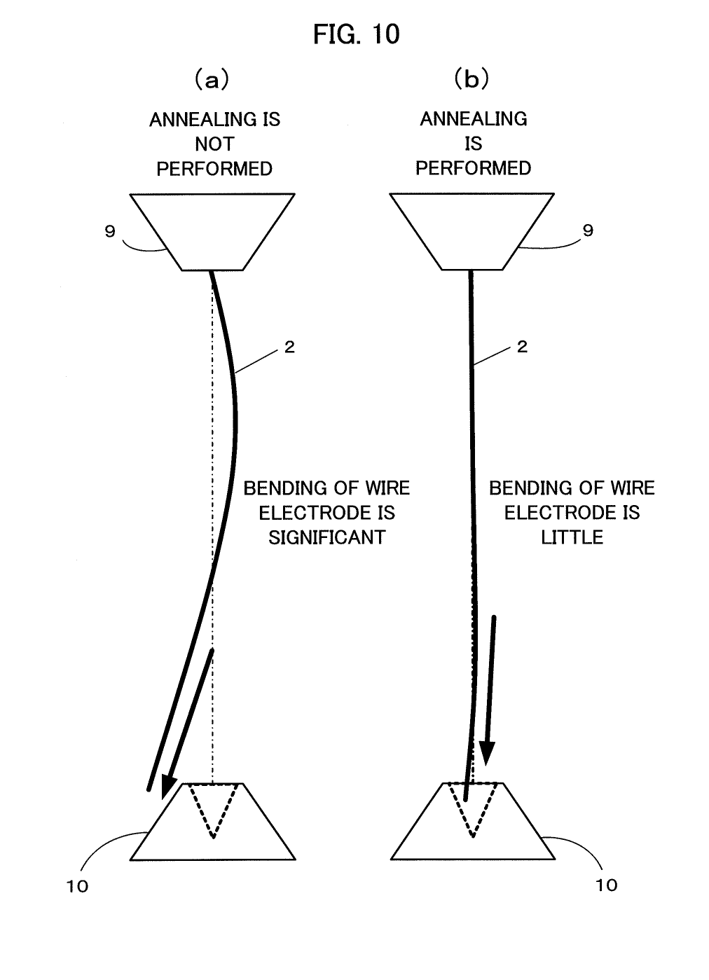

### DETAILED DESCRIPTION OF THE PREFERRED EMBODIMENTS

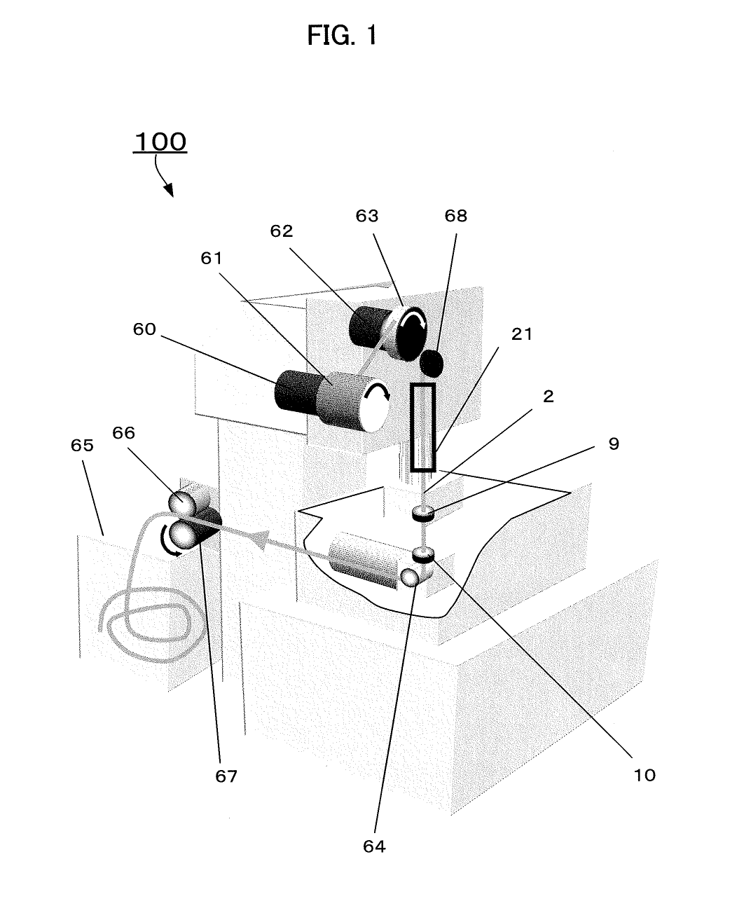

A wire electric discharge machine according to the present invention will be described using FIG. 1. A wire electric discharge machine 100 is formed with a wire electric discharge machine body and a controller (not illustrated) which controls a wire electric discharge machine body.

A wire bobbin 61 around which a wire electrode 2 is wound is given a predetermined low torque commanded in a direction opposite to a leading direction of the wire electrode 2 by a feeding unit torque motor 60. The wire electrode 2 fed from this wire bobbin 61 passes through a brake roller 63 via a plurality of guide rollers (not illustrated), runs via an upper guide 9, a lower guide 10 and a lower guide roller 64, is pinched between a pinch roller 66 and a feed roller 67 and is collected in a wire electrode collecting box 65. The feed roller 67 is driven by a wire electrode feed motor (not illustrated).

The brake roller 63 is driven by the brake motor 62, the feed roller 67 is driven by the wire electrode feed motor (not illustrated), and the tension of the wire electrode 2 between the brake roller 63 and the feed roller 67 is adjusted by the brake roller 63 driven by the brake motor 62. That is, the brake motor 62 and the brake roller 63 form a wire tension applying device (brake portion). A tension detector 68 detects the degree of the tension of the wire electrode 2 running between the upper guide 9 and the lower guide 10.

A work (not illustrated) is arranged in an electric discharge machining area between the upper guide 9 and the lower guide 10, and a high frequency voltage is applied to the wire electrode 2 from a machining power source to perform electric discharge machining.

A heat resistant tube 21, which has an enough length to secure straightness of the wire required for a work thickness which enables automatic connection of the wire, is attached in a running portion of the wire electrode 2 fed from the wire bobbin 61 on the downstream side of the wire tension applying device (brake motor 62 and brake roller 63) but on the upstream side of the upper guide 9. This heat resistant tube 21 is desirably made of a material such as a ceramic which is heat resistant and in which a current does not flow. The coil 22 which causes high frequency dielectric heating is wound around this heat resistant tube 21. In addition, the heat resistant tube 21 around which the coil 22 is wound is collectively referred to as a ‘tube with a coil 20’.

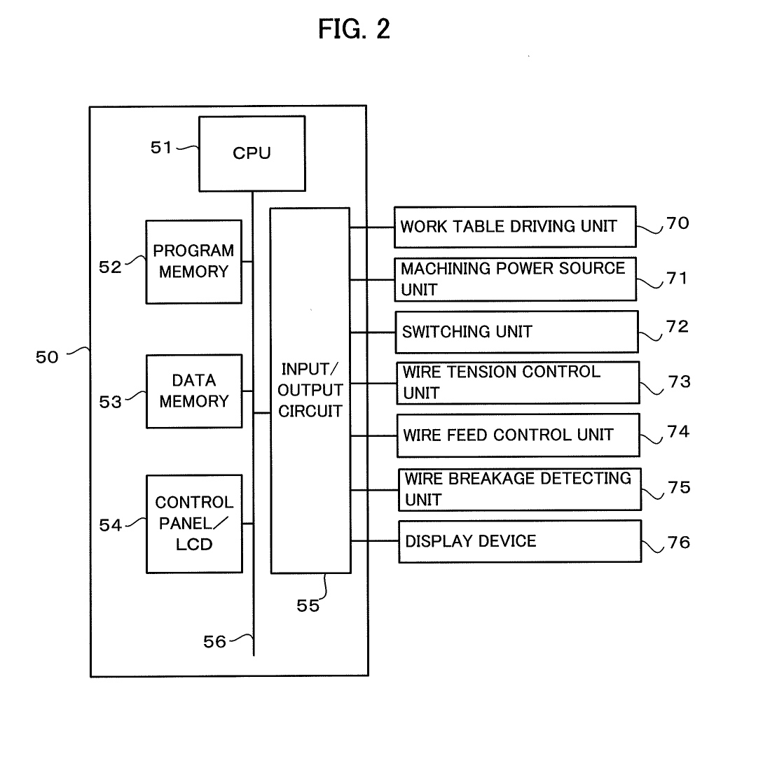

A controller which controls the wire electric discharge machine in FIG. 1 will be described using a block diagram of FIG. 2.

A controller 50 of the wire electric discharge machine has a central processing unit (hereinafter simply referred to as “CPU”) 51 composed of a microprocessor, and this CPU 51 is connected with a program memory 52, a data memory 53, a control panel 54 which has a liquid crystal display (LCD) and an input/output circuit 55 through a bus 56.

In the program memory 52, various programs are stored which control respective units of the wire electric discharge machine and the controller 50 itself of the wire electric discharge machine. Further, position data accompanying a machining program and various items of setting data which set other machining conditions are stored in the data memory 53. Furthermore, this data memory 53 is used as a memory which temporarily stores data for various computations performed by the CPU 51. The input/output circuit 55 is connected with a work table driving unit 70, a machining power source unit 71, a switching unit 72, a wire tension control unit 73, a wire feeding control unit 74, a wire breakage detecting unit 75 and a display device 76.

The work table driving unit 70 and the machining power source unit 71 form known configurations, and are controlled according to a normal method upon execution of machining. The switching unit 72 supplies a high frequency current from the machining power source unit 71 to the coil 22 to dielectric-heat the wire electrode 2 inserted into the tube with the coil 20. The machining wire tension control unit 73 controls a motor which drives the brake roller according to information from the tension detector 68. The wire feed control unit 74 controls the motor which drives the feed roller. The machining wire tension control unit 73 and the wire feed control unit 74 control the tension of the wire electrode so that it agrees with a commanded value.

The wire breakage detecting unit 75 detects breakage when the wire is broken during execution of machining, and a mechanism of a conventional method (such as a method of detecting a current flowing in the wire, or a method of the tension detector 68 which detects a load applied to a shaft of the roller against which a running wire electrode is pressed) is used. The display device 76 displays various items of data of the wire dielectric discharge machine 100 in various formats.

In the memory of the controller 50 of the wire electric discharge machine, programs for a position detection/recording of wire connection failure and a program for executing automatic connection processing are stored. This means that the wire electric discharge machine has an automatic connection device. It is a known technique that the controller of the wire electric discharge machine has these programs, and therefore will not be described.

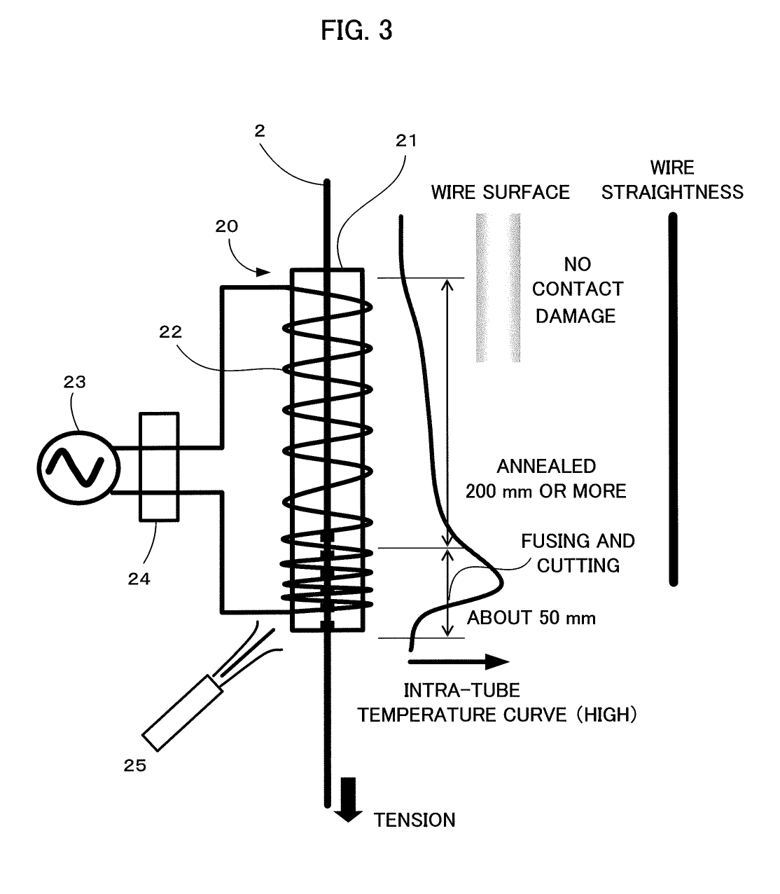

A dielectric heating method of a dielectric heating tube with a variable pitch coil to be adopted in the wire electric discharge machine according to the present invention will be described using FIG. 3.

As described above, the heat resistant tube 21, which has an enough length to secure straightness of the wire required for a work thickness which enables automatic connection of the wire, is attached in a running portion of the wire electrode 2 fed from the wire bobbin 61 on the downstream side of the wire tension applying device (brake motor 62 and brake roller 63) but on the upstream side of the upper guide 9. This heat resistant tube 21 is desirably made of a material such as a ceramic which is heat resistant and in which a current does not flow. The coil 22 which causes high frequency dielectric heating is wound around this heat resistant tube 21. At both ends of the coil 22, a power supply line is connected from a high frequency generating device 23 of the electric discharge power source device (not illustrated) through a switching circuit 24. By interposing the switching circuit 24 between the coil 22 and the high frequency generating device 23, it is possible to have the electric discharge machine power source serves also as the high frequency generating device 23.

It is generally known that, in order to increase a temperature in dielectric heating, it is necessary to increase the frequency of current, increase coil turns, or reduce the radius of coil winding. Hence, it is effective to change the coil turns depending on a location, that is, to change the coil density, in order to generate a temperature distribution using the same coil, and the density of coil winding is made lower in the first half of the wire of the heat resistant tube 21 on the inlet side and is made higher near the outlet, so that heat is generated in different manners using the same current, the coil is gradually heated in the first half of the heat resistant tube 21 on the inlet side, is annealed, and has the maximum temperature near the outlet of the heat resistant tube 21.

It is desirable to perform annealing in as wide a range as possible to secure straightness of the wire electrode 2, and the length of the coil portion is determined so as to correspond to the length of a section (for example, a section which is 25 mm long from the fused front end) of a front end portion of the cut wire electrode 2 that is made thin and sharp enough to allow the section to be inserted in a dice guide and reach a sub dice guide located below a dice guide.

Hereinafter, an example of the dielectric heating tube with the variable pitch coil used in the wire dielectric machine will be described.

As the thickness of the wire electrode 2 is 0.1 to 0.3 mm, a tube having the inner diameter of about 3 to 5 mm and the outer diameter of 5 to 10 mm is used for the heat resistant tube 21.

A method of calculating a section for changing the turns density of the coil 22 will be described below. In the structure of the wire electric discharge machine, the maximum length of the heat resistant tube 21 which can be inserted between the brake roller 63 which applies the tension to the wire electrode 2 and the upper guide 9 which supports the wire electrode 2 on the upper side is about 300 mm. In order to make a section which is 25 mm long from the fused front end in this 300 mm thin and sharp, the section of 50 mm long, which is twice as much as the above section of 25 mm long, is considered to be a fusing and cutting section. Further, a section of 250 mm long, the result of subtraction of the length of the above section of 50 mm from the total tube length of 300 mm is considered to be an annealing section on the upstream side.

That is, in this example, a turn density of the coil in a first section (annealing section) of the heat resistant tube 21 between an upper end portion on the wire electrode inlet side and a portion which is a predetermined distance (50 mm) away from the lower end portion on the wire electrode outlet side toward the upper end portion on the wire electrode inlet side is made lower than a turns density of the coil in a second section (fusing and cutting section) of the heat resistant tube 21 between the lower end portion and the portion which is the predetermined distance away from the lower end portion toward the upper end portion. These are the features of the wire electric discharge machine.

A method of calculating coil turns will be described below. The coil turns which can generate an amount of heat that enables fusing in a section of 10 mm (the sum of 5 mm before a fusing point and 5 mm after the fusing point) is calculated. If the result of the calculation is 100 turns (that is, in case where the coil turns is 100 per 10 mm of the fusing and cutting section), then the coil turns which can generate an amount of heat that enables fusing in a case where the fusing and cutting section is 50 mm (in this connection, it should be noted that fusing is not performed in the annealing section on the upstream side).

A method of calculating a coil turns density will be described below. The coil density in the annealing section (250 mm) on the upstream side is 20 per 10 mm, and the coil density in the fusing and cutting section (50 mm) of the heat resistant tube 21 on the outlet side is 100 per 10 mm as described above. The wire diameter of the coil is about 0.2 to 0.5 mm, an insulating film is applied to the wire outer periphery and the coil is lap-wound in a high density portion. The coil is trapped with heat, and therefore adopts an open structure in which the coil outer periphery is naturally cooled. Further, in the coil outer periphery in the fusing and cutting section in which the temperature becomes highest, such a structure (cooling air nozzle 25) as blows compressed air for cooling upon fusing is also added.

Upon wire automatic connection, running of the wire electrode 2 is stopped, the wire electrode 2 is pulled between the brake roller 63 and the winding rollers (pinch roller 66 and feed roller 67) under tension, the high frequency current is applied to the coil 22 while applying the tension, and the wire electrode 2 inside the heat resistant tube 21 is heated by means of the dielectric heating phenomenon.

The wire electrode 2 stops without running, and is heated inside the resistant tube 21, and annealing removes the original curling, so that straightness improves. When a time further advances, a temperature rise near the outlet of the heat resistant tube 21 with a high coil density is significant, so that fusing using heat occurs, and it is possible to obtain a wire cut portion having a sharp front end. At a moment when fusing is detected, a tension detecting device detects that the tension changes, immediately stops a current supply, stops further heating and finishes a cutting operation.

Further, straightness during machining is improved by supplying a high frequency current from a power source unit (high frequency generating device 23) in conjunction with a wire feed command during machining, heating the wire electrode 2 which passes in the heat resistant tube 21 by dielectric heating and performing annealing. The wire electrode 2 which travels in the heat resistant tube 21 is gradually heated, and has the highest temperature near the outlet at which the coil 22 turns density is highest. However, the wire electrode 2 is running, and is fed outside the heat resistant tube 21 before fusing so that wire disconnection never happens during machining. Further, two types of coils 22 may be prepared and the first half may be used for annealing with a little coil turns and the outlet portion may be used for cutting with a great coil turns.

1. The wire electric discharge machine comprising a wire tension applying device which leads a wire electrode wound around a wire bobbin and applies a tension to the wire electrode, an upper guide portion which is provided on an upper portion of an electric discharge machining area, and a wire running route which goes through a lower guide portion provided in a lower portion of the electric discharge machining area, wherein:
a dielectric heating tube, which is formed with a heat resistant tube in which the wire electrode is inserted and a coil which is wound around the heat resistant tube and causes high frequency dielectric heating, is arranged on a downstream side of the wire tension applying device but on the upstream side of the upper guide portion; and
a turns density of the coil in a first section of the heat resistant tube between an upper end portion on the wire electrode inlet side and an intermediate portion which is a predetermined distance away from a lower end portion on the wire electrode outlet side toward the upper end portion is made lower than a turns density of the coil in a second section of the heat resistant tube between the lower end portion and the intermediate point.
